(19) United States
(12) Patent Application Publication
(10) Pub. No.: US 2025/0044473 A1
(43) Pub. Date: Feb. 6, 2025

(54) METHOD OF IDENTIFYING A PRODUCTIVE INTERVAL ALONG A WELL

(71) Applicant: SAUDI ARABIAN OIL COMPANY, Dhahran (SA)

(72) Inventors: Jun Gao, Dhahran (SA); Hyung Tae Kwak, Dhahran (SA)

(73) Assignee: SAUDI ARABIAN OIL COMPANY, Dhahran (SA)

(21) Appl. No.: 18/362,624

(22) Filed: Jul. 31, 2023

(51) Int. Cl. G01V 1/50; E21B 25/00; E21B 49/00

(52) U.S. Cl. CPC G01V 1/50; E21B 25/00; E21B 49/00; E21B 43/26; G01V 2210/6163; G01V 2210/6169; G01V 2210/6242; G01V 2210/6244; G01V 2210/665

(57) ABSTRACT

Methods and systems are disclosed. Methods may include obtaining well data along an interval of a well and identifying a first candidate interval within the interval using the well data. The well data includes acoustic data and porosity data. A formation surrounding the well within the first candidate interval includes micropores. The methods may further include determining mechanical parameter data along the first candidate interval based on the acoustic data and identifying a second candidate interval within the first candidate interval based on the mechanical parameter data and the porosity data. The methods may still further include determining water saturation data along the second candidate interval based on the well data, identifying a productive interval within the second candidate interval based on the water saturation data and a water saturation threshold, and determining a completion plan for the well based on the productive interval.

### BACKGROUND

Carbonate and sandstone reservoirs store and produce more than half of the hydrocarbons in the world. However, hydrocarbons stored in carbonate and sandstone reservoirs have been overlooked in the past and continue to be difficult to locate as the resistivity values associated with rock layers that may store the hydrocarbons within the carbonate and sandstone reservoirs may register unexpectedly low resistivity values similar to that of water. Such reservoirs or portions thereof are colloquially referred to as “low resistivity pay.” Low resistivity values have traditionally been interpreted to indicate the presence of water and little-to-no hydrocarbons when economical hydrocarbons, such as dry oil, and little-to-no water may actually exist.

One reason carbonate reservoirs may register low resistivity values where hydrocarbons are present may be due to the extensive and complex multi-modal pore systems, that may include micropore systems, within some carbonate reservoirs. These micropore systems may store significant amounts of hydrocarbons.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes obtaining well data along an interval of a well and identifying a first candidate interval within the interval using the well data. The well data includes acoustic data and porosity data. A formation surrounding the well within the first candidate interval includes micropores. The method further includes determining mechanical parameter data along the first candidate interval based on the acoustic data and identifying a second candidate interval within the first candidate interval based on the mechanical parameter data and the porosity data. The method still further includes determining water saturation data along the second candidate interval based on the well data, identifying a productive interval within the second candidate interval based on the water saturation data and a water saturation threshold, and determining a completion plan for the well based on the productive interval.

In general, in one aspect, embodiments relate to a system. The system includes a computer system and a production management system. The computer system is configured to receive well data along an interval of a well and identify a first candidate interval within the interval using the well data. The well data includes acoustic data and porosity data. A formation surrounding the well within the first candidate interval includes micropores. The computer system is further configured to determine mechanical parameter data along the first candidate interval based on the acoustic data and identify a second candidate interval within the first candidate interval based on the mechanical parameter data and the porosity data. The computer system is still further configured to determine water saturation data along the second candidate interval based on the well data and identify a productive interval within the second candidate interval based on the water saturation data and a water saturation threshold. The production management system is configured to determine a completion plan for the well based on the productive interval.

In general, in one aspect, embodiments relate to a non-transitory computer-readable memory having computer-executable instructions stored thereon that, when executed by a computer processor, perform steps. The steps include receiving well data along an interval of a well and identifying a first candidate interval within the interval using the well data. The well data includes acoustic data and porosity data. A formation surrounding the well within the first candidate interval includes micropores. The steps further include determining mechanical parameter data along the first candidate interval based on the acoustic data and identifying a second candidate interval within the first candidate interval based on the mechanical parameter data and the porosity data. The steps still further include determining water saturation data along the second candidate interval based on the well data, identifying a productive interval within the second candidate interval based on the water saturation data and a water saturation threshold, and determining a completion plan for the well based on the productive interval.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1A-1C show micropores in accordance with one or more embodiments.

FIG. 2 illustrates a rock coring system in accordance with one or more embodiments.

FIG. 3 illustrates a well logging system in accordance with one or more embodiments.

FIG. 4 displays well data in accordance with one or more embodiments.

FIGS. 5-7 display mechanical parameter data and porosity data in accordance with one or more embodiments.

FIG. 8 displays water saturation data in accordance with one or more embodiments.

FIG. 9 shows a flowchart in accordance with one or more embodiments.

FIG. 10 illustrates a computer system in accordance with one or more embodiments.

FIG. 11 illustrates a hydraulic fracturing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before.” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a productive interval” includes reference to one or more of such intervals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

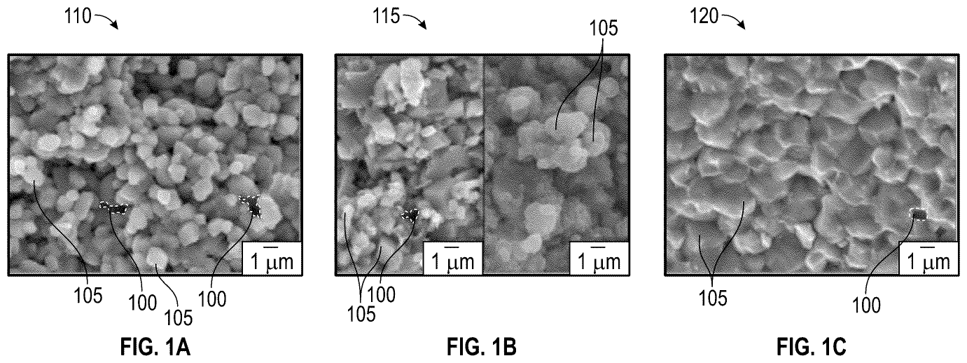

In the following description of FIGS. 1-11, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to identify one or more productive intervals along a well within a formation using well data. The portion of the formation surrounding each productive interval may store hydrocarbons within specific types of micropores. Each of those portions of the formation may be referred to as “pay.” In some embodiments, the well data may include acoustic data, porosity data, and nuclear magnetic resonance (NMR) data. Each type of well data may be determined or derived from well logs and/or measured from rock cores. The methods may rely on the idea that certain types of micropores may store hydrocarbons while other types of micropores may not store hydrocarbons.

Constituents of rock may include grains and pores. The grains may be collectively referred to as matrix. For example, the grains may be made up of low-magnesium calcite (LCM) microcrystals that formed during mineralogical stabilization of metastable sediments during diagenesis. The voids or space between the grains may be referred to as pores. In some embodiments, rock may include intergranular micropores 100 between grains 105, which may include micrograins, as FIGS. 1A-1C show. As the name suggests, each micrograin and micropore 100 is roughly one micrometer (μm) or less in diameter as shown by the scale bar in FIGS. 1A-1C. In other embodiments, rock may include intragranular micropores 100 where micropores 100 may also or alternatively exist within the grains 105. Hereinafter, the generic term “grains” may refer to macrograins and/or micrograins unless specifically denoted otherwise. Similarly, the generic term “pores” may refer to macropores and/or micropores 100 unless specifically denoted otherwise.

Features associated with the grains and pores of rock may be categorized using one or more classification systems. Features may include, but are not limited to, shape, packing, edge density, contacts, and pore throats associated with the grains, pores, or both. Further, some classification systems may categorize the pore throats, which may distinctly separate one micropore system from another in rock, by number, size, and distribution. The classification systems and nomenclature associated with each classification system are vast among the literature. Examples of classification systems include textural classes, pore fabric types, pore space architecture, etc. The class or type rock is categorized into may be characterized by distinct petrophysical properties, such as porosity and permeability, of the rock.

One classification system may be referred to as main textural classes where the organization of grains 105 may be categorized as granular (framework), fitted (mosaic), or clustered. A second classification system may classify the shape of grains 105 as euhedral 110, subhedral 115, or anhedral 120 as each of FIGS. 1A-1C show. Euhedral 110 may refer to grains 105 with well-defined faces. Subhedral 115 may refer to grains 105 with moderately-defined faces. Anhedral 120 may refer to grains 105 with poorly-defined faces.

A third classification system may classify rock as type I, type II, or type III. In some embodiments, the pore throat size, porosity, and permeability may all decrease from type I to type II to type III. Type I rock may have a pore throat size of approximately 0.7 micrometers (μm), porosity of approximately 20%, and permeability of approximately 1-20 millidarcy (md). Type II rock may have a pore throat size of approximately 0.2 μm, porosity of approximately 10-20%, and permeability of approximately 0.1-1.0 md. Type III rock may have a pore throat size of less than 0.06 μm, porosity of less than 10%, and permeability of less than 0.1 md. A fourth classification system may classify the packing of micropores 100 as granular (or micro-rhombic), clustered, or fitted. A fifth classification system may classify the contacts between grains 105 as point, punctic, serrated, or coalescent.

Other classification systems, additional types or classes, and/or sub-types or sub-classes may also be used to classify each feature of rock where some terms may be synonymous or nearly synonymous to other terms. For example, rhombic and type I may be nearly synonymous to euhedral 110, polyhedral and type II to subhedral 115, and rounded and type III to anhedral 120. A person of ordinary skill in the art will appreciate that the choice of classification system and choice of nomenclature associated with the classification system that are used to categorize a feature of rock should in no way limit the scope of the disclosure.

One or more layers of rock make up a formation. Some layers of rock within the formation may include complex, multi-modal micropore systems. As such, each rock layer may be uniquely classified relative to other rock layers within the formation using one or more classification systems. If the formation includes a reservoir, the reservoir may also be made up of rock layers uniquely classified relative to other rock layers within the reservoir.

In some reservoirs, certain categories of a feature of a rock layer may be associated with the rock layer storing hydrocarbons while other categories of the feature of the rock layer may be associated with the rock layer not storing hydrocarbons. For example, a rock layer within a reservoir categorized as euhedral 110 or subhedral 115 may store hydrocarbons, while a rock layer within the reservoir categorized as anhedral 120 may not store hydrocarbons. A person of ordinary skill in the art will appreciate that other synonymous or nearly synonymous terms to euhedral 110, subhedral 115, and/or anhedral 120 may replace the term(s) used in the example above without departing from the scope of the disclosure. Further, a person of ordinary skill in the art will appreciate that certain categories of other features of a rock layer may also be associated with the rock layer storing hydrocarbons while other categories of the other features of the rock layer may be associated with the rock layer not storing hydrocarbons.

However, in unconventional reservoirs, such as carbonate and sandstone reservoirs, the stored hydrocarbons may be overlooked if a resistivity log is relied on to locate the stored hydrocarbons. Unconventional reservoirs or portions thereof that store hydrocarbons surrounding intervals that register low resistivity values (between 0.5 ohm-meters to 5.0 ohm-meters) may be colloquially referred to as “low resistivity pay.” The term may be considered a contradiction of terms as low resistivity values have traditionally been interpreted to indicate the presence of water and little-to-no economical hydrocarbons when the opposite may actually exist. As such, the water cut may be low when the economical hydrocarbons are produced from the reservoir.

One reason unconventional reservoirs or portions thereof that store hydrocarbons surrounding intervals register low resistivity values may be due to the presence of wetting brine within the extensive and complex multi-modal micropore systems as the brine may create a conductive network via the micropores 100.

To locate pay within an unconventional reservoir, well data and the idea that certain categories of a feature of rock may be associated with the rock storing hydrocarbons while other categories of the feature of the rock may be associated with the rock not storing hydrocarbons may be relied on. Well data may include petrophysical properties measured or derived from rock cores and/or well logs. The rock cores may be collected from a formation using a rock coring system that simultaneously drills a well. The well logs may be collected along an interval of the well using a well logging system. If the well logging system is used once a portion or all of the well is drilled, a wireline well logging system may be used. If the well logging system is used during drilling of the well, a logging-while-drilling well logging system may be used.

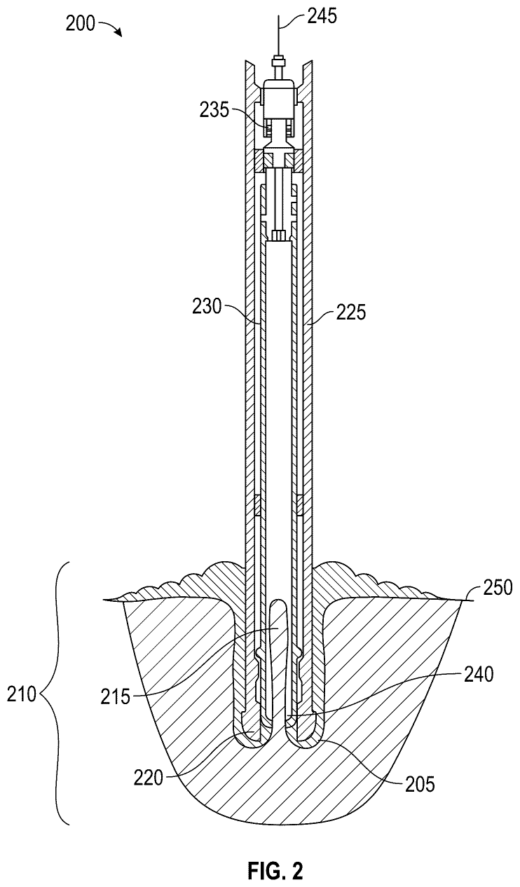

FIG. 2 illustrates a rock coring system 200 drilling a well 205 in accordance with one or more embodiments. The rock coring system 200 is configured to simultaneously drill the well 205 within a formation 210 and retrieve one or more rock cores 215 along an interval of the well 205. As such, the rock coring system 200 may be considered part of a drilling system. The rock coring system 200 may collect rock cores 215 continuously or at intervals while drilling the well 205. To do so, the rock coring system 200 may include a coring bit 220 attached to a core barrel 225. Within the core barrel 225, an inner barrel 230 is disposed between a swivel 235 attached to an upper portion of the core barrel 225 and a core catcher 240 is disposed close to the coring bit 220. The coring bit 220 consists of an annular cutting or grinding surface configured to flake, gouge, grind, or wear away the formation 210 at the base or “toe” of the well 205. A central axial orifice is configured to allow a cylindrical rock core 215 to pass through. The annular cutting surface of the coring bit 220 typically includes embedded polycrystalline compact diamond (PDC) cutting elements.

The inner barrel 230 within the core barrel 225 may be disposed above or behind the coring bit 220. Further, the inner barrel 230 may be separated from the coring bit 220 by the core catcher 240. As the coring bit 220 grinds away the formation 210, the cylindrical rock core 215 passes through the central orifice of the coring bit 220 and through the core catcher 240 into the inner barrel 230 as the coring bit 220 advances deeper into the formation 210. The inner barrel 230 may be attached by the swivel 235 to the remainder of the core barrel 225 to permit the inner barrel 230 to remain stationary as the core barrel 225 rotates together with the coring bit 220. When the inner barrel 230 is filled with the rock core 215, the core barrel 225 containing the rock core 215 may be raised and retrieved at the surface of the earth 250. The core catcher 240 serves to grip the bottom of the rock core 215 and, as lifting tension is applied to the drillstring 245 and the core barrel 225, the formation 210 under the rock core 215 breaks away from the undrilled formation 210 below it. The core catcher 240 may retain the rock core 215 so that it does not fall out the bottom of the core barrel 225 through the annular orifice of the coring bit 220 as the core barrel 225 is raised to the surface of the earth 250.

In addition to collecting rock cores 215 while drilling the well 205, smaller “sidewall cores” may be obtained after drilling a portion or all of the well 205. A sidewall coring system (not shown) may be lowered by wireline into the well 205. When deployed, the sidewall coring system presses or clamps itself against the wall of the well 205 and a rock core 215 is obtained either by drilling into the wall of the well 205 with a hollow coring bit or by firing a hollow bullet into the wall of the well 205 using an explosive charge. More than 50 such sidewall cores may be obtained during a single deployment of a sidewall coring system into the well 205. Hereinafter, the term “rock coring system” is used to describe the rock coring system 200 as illustrated in FIG. 2 or the sidewall coring system.

Rock cores 215 provide representative samples of the formation 210. Further, rock cores 215 permit physical examination and direct measurement or identification of petrophysical properties such as, but not limited to, porosity, permeability, fluid saturation, density, lithology, and texture in a laboratory setting. Analysis of rock cores 215 may further provide evidence of presence, distribution, and deliverability of hydrocarbons within a reservoir.

Under ideal circumstances, a rock core 215 is recovered as a single, continuous, intact cylinder of the formation 210. However, frequently, the rock core 215 takes the form of several shorter cylindrical segments separated by breaks. The breaks may be a consequence of stresses experienced by the rock core 215 during coring or may be caused by pre-existing vugs, channels, and/or fractures within the formation 210.

In general, each extracted rock core 215 may be up to 15 centimeters in diameter and approximately ten meters long. To prepare each rock core 215 for testing in a laboratory setting, each rock core 215 may be cut and ground into core plugs. Each core plug may be a few centimeters in diameter and approximately five centimeters long, though other shapes and dimensions may be used. Further, each core plug may be cut and ground along a particular axis of the well 205, such as parallel or perpendicular to the well 205.

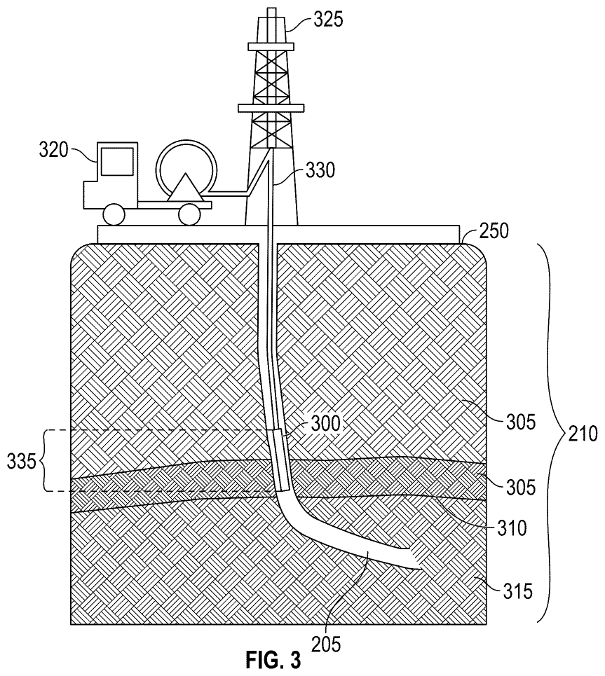

FIG. 3 illustrates a well logging system 300 downhole in the well 205 in accordance with one or more embodiments. Prior to deploying the well logging system 300 downhole, the well 205 is partially or completely drilled within the formation 210 using the rock coring system 200 as previously described relative to FIG. 2. The well 205 may traverse layers of rock 305 separated by geological boundaries 310 and/or other structural features before ultimately penetrating the reservoir 315. Though not shown in FIG. 3, the reservoir 315 may also include layers of rock 305. In some embodiments, the reservoir 315 may be a heterogeneous carbonate reservoir.

In some embodiments, the well logging system 300 is lowered into the well 205 following the removal of the rock coring system 200. The well logging system 300 may be supported by a truck 320 and derrick 325 above ground. For example, the truck 320 may carry a conveyance mechanism 330 used to lower the well logging system 300 into the well 205. The conveyance mechanism 330 may be a wireline, coiled tubing, or drillpipe that may include means to provide power to the well logging system 300 and a telemetry channel from the well logging system 300 to the surface of the earth 250. In some embodiments, the well logging system 300 may be translated along the well 205 to acquire well data over multiple portions of an interval 335.

The well logging system 300 used to collect the well data over the interval may be, but is not limited to, an acoustic logging tool (which may be a sonic logging tool), density logging tool, neutron porosity logging tool, and nuclear magnetic resonance (NMR) logging tool. As such, the well data may include, but are not limited to, an acoustic log (which may be a sonic log), density log, neutron porosity log, NMR log, and any combination or derivation thereof.

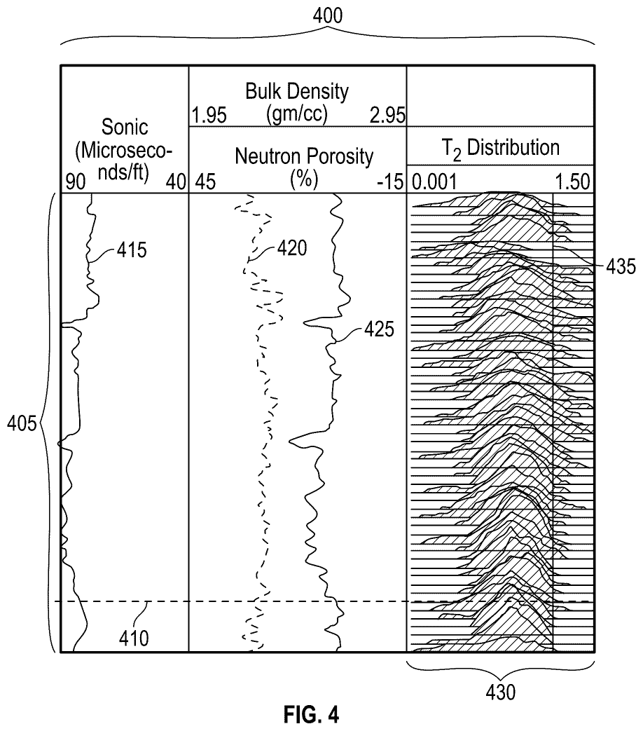

FIG. 4 displays well data 400 along an interval 405 of the well 205 in accordance with one or more embodiments. The interval 405 includes one or more positions 410. In some embodiments, the distance between each position 410 is based on the resolution of the well logging system 300. A common resolution of the well logging system 300 is 0.6 meters (or approximately 2 feet).

While FIG. 4 displays the well data 400 as well logs, the well data 400 may only include data from rock cores 215 collected along the interval 405, or may include data from both well logs and rock cores 215. Further, in some embodiments, the well logs may be calibrated using well data 400 determined from rock cores 215. The well data 400 displayed in FIG. 4 shows a sonic log on track 1, a neutron porosity log and bulk density log on track 2, and an NMR log on track 3. However, hereinafter, the sonic log is generically referred to as acoustic data 415, the neutron porosity log as porosity data 420, the bulk density log as density data 425, and the NMR log as NMR data 430.

In some embodiments, the acoustic data 415 is used to determine shear wave velocity data and compressional wave velocity data of seismic waves as they propagate through the formation 210 within the interval 405. The shear wave velocity data and the compressional wave velocity data may be a function of porosity, texture, and stress of the formation 210.

In some embodiments, the porosity data 420 may be derived from the acoustic data 415. For example, the porosity data 420 may be derived from the acoustic data 415 using the empirical Wyllie time-average equation:

$$\frac{1}{v} = \frac{ϕ}{{v}_{f}} + \frac{1 - ϕ}{{v}_{m}} , \qquad Equation ( 1 )$$

where ϕ is total porosity, v is the phase velocity determined from the acoustic data 415, vₘ is the velocity of the rock matrix or grains 105 determined from the acoustic data 415, and v_{f} is the velocity of the fluid within the rock pores determined from the acoustic data 415. A person of ordinary skill in the art will appreciate that Equation (1) may be alternatively written and used in terms of interval traveltimes as:

$$Δ t = ϕ Δ {t}_{f} + ( 1 - ϕ ) Δ {t}_{m} , \qquad Equation ( 2 )$$

where Δt is the interval traveltime, Δt_{f} is the interval traveltime of the fluid within the rock pores, and Δtₘ is the interval traveltime of the rock matrix or grains 105 without departing from the scope of the disclosure.

In some embodiments, the well data 400 further includes velocity deviation data and scanning electron microscopy (SEM) images of portions of the rock cores 215. The velocity deviation data may be determined from the acoustic data 415 and porosity data 420. In one or more embodiments, the velocity deviation data may be used to categorize one or more features of rock such as features associated with micropores 100 of the rock.

One or more first candidate intervals are identified within the interval 405 using some of the well data 400. The formation 210 surrounding the well 205 within the first candidate interval includes rock with micropores 100.

In some embodiments, the first candidate interval is identified within the interval 405 using the NMR data 430 and a transverse relaxation time threshold 435. For example, FIG. 4 shows a transverse relaxation time threshold 435 of 210 milliseconds (ms) though the transverse relaxation time threshold 435 may be between 200 ms and 300 ms, inclusive. In some embodiments, the value of the transverse relaxation time threshold 435 may be determined from rock core studies from one or more wells 205. Further, the NMR data 430 may be considered a measure of permeability as the transverse relaxation time distribution, denoted T₂, may reflect pore size distribution. The first candidate interval is identified at positions 410 within the interval 405 where the majority of the NMR data 430 is below the transverse relaxation time threshold 435. In the example of FIG. 4, the first candidate interval is the interval 405 as all of the majority of the NMR data 430 is below the transverse relaxation time threshold 435. The transverse relaxation time threshold 435 may separate the interval 405 such that the formation 210 surrounding the interval 405 where the NMR data 430 is below the transverse relaxation time threshold 435 includes rock with micropores 100 while the formation 210 surrounding the interval 405 where the NMR data 430 is above the transverse relaxation time threshold 435 includes rock with macropores.

In other embodiments, the first candidate interval is identified within the interval 405 using rock cores 215 obtained along the interval 405 of the well 205 and SEM. SEM may be used to generate one or more images of each of the core plugs where each image is associated with a position 410 within the interval 405. Each image is of pores. The first candidate interval is identified at the position 410 within the interval 405 where each image is of micropores 100.

Mechanical parameter data is then determined along the first candidate interval. The mechanical parameter may include, but is not limited to, Young's modulus, bulk modulus, and shear modulus. The mechanical parameter data includes mechanical values, each of which is associated to a position 410 within the first candidate interval.

The mechanical parameter data may be determined using the acoustic data 415 and, in some embodiments, the density data 425. In some embodiments, Young's modulus Y may be determined at each position 410 within the first candidate interval as:

$$Y = \frac{ρ {V}_{s} ( 2 {V}_{c}^{2} - 4 {V}_{s}^{2} )}{{V}_{c}^{2} - {V}_{s}^{2}} , \qquad Equation ( 3 )$$

where p is density, Vₛ is shear wave velocity, and Vₑ is compressional wave velocity. The density p may come from the density data 425 as displayed in FIG. 4. The shear wave velocity Vₛ and the compressional wave velocity Vₑ may be derived from the acoustic data 415. In other embodiments, bulk modulus K may be determined at each position 410 within the first candidate interval as:

$$K = ρ ( {V}_{c}^{2} - \frac{4}{3} {V}_{s}^{2} ) . \qquad Equation ( 4 )$$

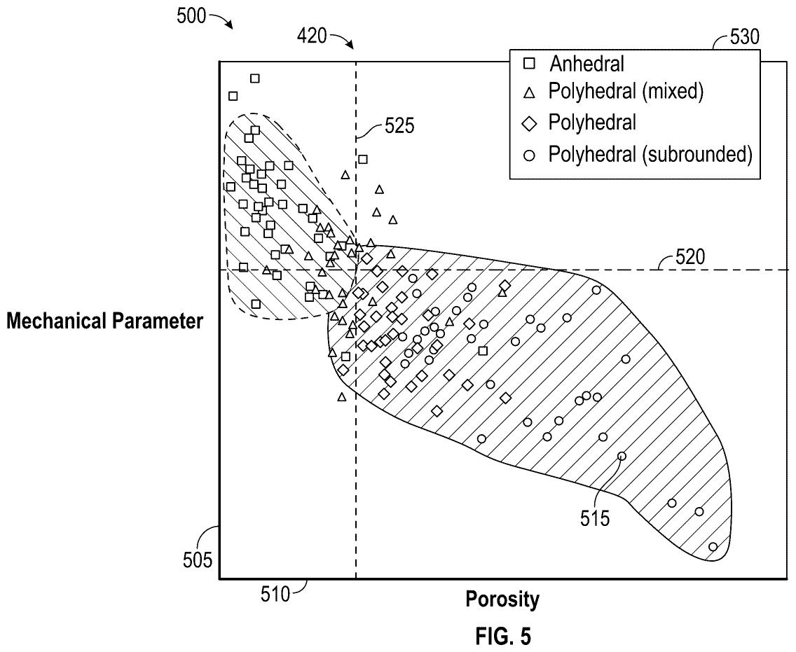

A second candidate interval is identified within the first candidate interval using, at least in part, the mechanical parameter data and the porosity data 420. In some embodiments, the second candidate interval may be identified at each position 410 within the first candidate interval where an associated mechanical value among the mechanical parameter data is below a mechanical parameter threshold and an associated porosity value among the porosity data 420 is above a porosity threshold. In some embodiments, the value of the mechanical parameter threshold and porosity threshold may be determined from rock core studies from one or more wells 205. FIGS. 5-7 each illustrate embodiments of this idea in accordance with one or more embodiments.

FIG. 5 shows a plot of mechanical parameter data 500 versus porosity data 420 in accordance with one or more embodiments. The mechanical parameter data 500 is plotted along the ordinate 505. The mechanical parameter data 500 may be Young's modulus data, bulk modulus data, or shear modulus data. The porosity data 420 is plotted along the abscissa 510. As such, each point 515 is associated to a mechanical value and a porosity value. Though not shown, each point 515 is also associated with a position 410 within the first candidate interval. The plot further includes a mechanical parameter threshold 520 and porosity threshold 525 using dashed lines. The position 410 associated to each point 515 that exists below the mechanical parameter threshold 520 and above the porosity threshold 525 may then be identified as a position 410 within the second candidate interval.

As shown by the key 530 in FIG. 5, separating each point 515 by the mechanical parameter threshold 520 and porosity threshold 525 may separate the points 515 associated with the first candidate interval by, for the most part, anhedral 120 and polyhedral/subhedral 115. As such, the second candidate interval may only include, for the most part, polyhedral/subhedral 115.

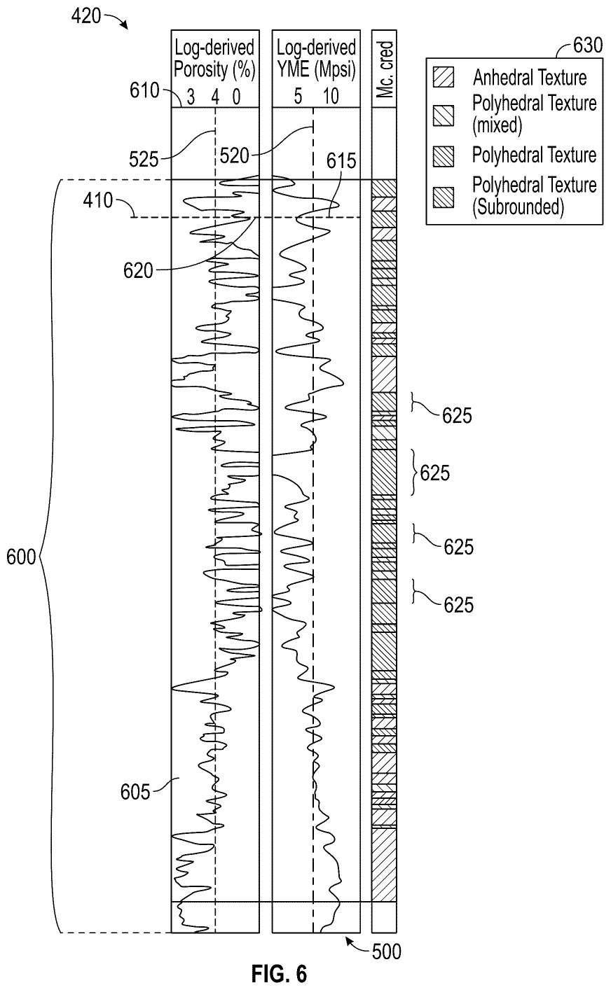

FIG. 6 shows an alternative plot of mechanical parameter data 500 versus porosity data 420 in accordance with one or more embodiments. In FIG. 6, the mechanical parameter data 500 and the porosity data 420 are plotted relative to the first candidate interval 600 as shown along the ordinate 605. The mechanical parameter data 500 may still be Young's modulus data, bulk modulus data, or shear modulus data. Now, the porosity data 420 is plotted on track 1 where the abscissa 610 is porosity. The porosity threshold 525 is shown by the dashed line on track 1. The mechanical parameter data 500 is plotted on track 2 where the abscissa 610 is mechanical parameter. The mechanical parameter threshold 520 is shown by the dashed line on track 2. As previously described, each position 410 where the associated mechanical value 615 is below the mechanical parameter threshold 520 and associated porosity value 620 is above the porosity threshold 525 may be identified as a position 410 within the second candidate interval 625.

As shown by the key 630 in FIG. 6, separating mechanical values by the mechanical parameter threshold 520 and associated porosity values by the porosity threshold 525 may separate the associated positions 410 within the first candidate interval by, for the most part, anhedral 120 and polyhedral/subhedral 115. As such, the second candidate interval may only include, for the most part, polyhedral/subhedral 115.

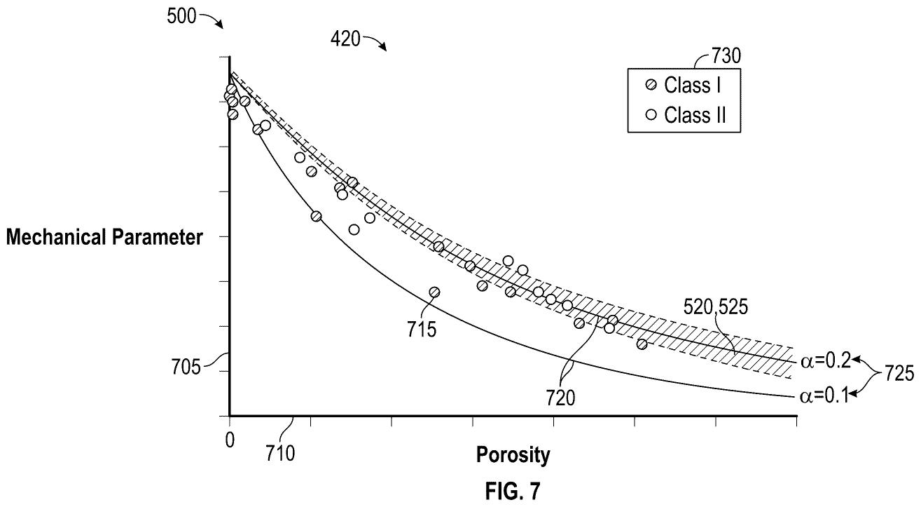

FIG. 7 shows still another alternative plot of mechanical parameter data 500 versus porosity data 420 in accordance with one or more embodiments. The mechanical parameter data 500 is plotted along the ordinate 705. The mechanical parameter data 500 may be bulk modulus data or shear modulus data. The porosity data 420 is plotted along the abscissa 710. As such, each point 715 is associated to a mechanical value and a porosity value. Though not shown, each point 715 is also associated with a position 410 within the first candidate interval.

FIG. 7 further shows models 720 that relate the mechanical parameter to porosity in accordance with one or more embodiments. Each model 720 may uniquely model the grains 105 and micropores 100 of the rock. The methods used to model the rock include, but are not limited to, a Hashin-Shtrikman upper bounds (HS+) method, Hashin-Shtrikman lower bounds (HS−) method, a differential effective medium (DEM) model, self-consistent (SC) model, and combinations thereof, such as DEM-SC or DEM-HS+.

The HS+ and HS− methods may model rock as a host constituent, such as calcite, with microporous grains where:

$${K}^{HS +} = {K}_{c} + \frac{{f}_{m}}{{( {K}_{m} - {K}_{c} )}^{- 1} + ( 1 - {f}_{m} ) {( {K}_{c} + \frac{4}{3} {μ}_{c} )}^{- 1}} , \qquad Equation ( 5 )$$

$${K}^{HS -} = {K}_{m} + \frac{( 1 - {f}_{m} )}{{( {K}_{c} - {K}_{m} )}^{- 1} + {{f}_{m} ( {K}_{m} + \frac{4}{3} {μ}_{m} )}^{- 1}} , \qquad Equation ( 6 )$$

$${μ}^{HS +} = {μ}_{c} + \frac{{f}_{m}}{{( {μ}_{m} - {μ}_{c} )}^{- 1} + \frac{2 ( 1 - {f}_{m} ) ( {K}_{c} + 2 {μ}_{c} )}{5 {μ}_{c} ( {K}_{c} + \frac{4}{3} {μ}_{c} )}} , \qquad Equation ( 7 )$$

$$and$$

$${μ}^{HS -} = {μ}_{m} + \frac{( 1 - {f}_{m} )}{{( {μ}_{c} - {μ}_{m} )}^{- 1} + \frac{2 {f}_{m} ( {K}_{m} + 2 {μ}_{m} )}{5 {μ}_{m} ( {K}_{m} + \frac{4}{3} {μ}_{m} )}} . \qquad Equation ( 8 )$$

In these equations, K^{HS+} and K^{HS-} are the upper and lower bounds of the bulk modulus, μ^{HS+} and μ^{HS-} are the upper and lower bounds of the shear modulus, K_{c} and μ_{c} are the bulk and shear moduli of the host constituent, Kₘ and μₘ are the bulk and shear moduli of the microporous grains, respectively, and fₘ is the grain volume fraction.

The DEM model models the effective elastic moduli of two-phase composites by adding infinitesimal quantities of inclusions, which represent the pores of rock, to a host phase using a coupled system of ordinary differential equations:

$$( 1 - y ) \frac{d}{dy} [ {K}^{*} ( y ) ] = P ( {K}_{2} - {K}^{*} ) ( y ) , \qquad Equation ( 9 )$$

$$and$$

$$( 1 - y ) \frac{d}{dy} [ {μ}^{*} ( y ) ] = Q ( {μ}_{2} - {μ}^{*} ) ( y ) , \qquad Equation ( 10 )$$

where K*(y) and μ*(y) are the effective bulk and shear moduli and K₂ and μ₂ are the bulk and shear moduli of the inclusions, respectively. Initial conditions include K*(0)=K₁ and ρ*(0)=μ₁ where K₁ and μ₁ are the bulk and shear moduli of the host constituent, respectively. The coefficients P and Q depend on the shape of the inclusions and the elastic moduli of the host and inclusion phases. For example, for ellipsoidal inclusions:

$$P = \frac{1}{3} {T}_{iijj} , \qquad Equation ( 11 )$$

$$and$$

$$Q = \frac{1}{5} ( {T}_{ijij} - \frac{1}{3} {T}_{iijj} ) , \qquad Equation ( 12 )$$

where the tensor Tᵢⱼₖₗ relates the uniform far-field strain to the strain within the ellipsoidal inclusion. The tensor Tᵢⱼₖₗ is a function of K₁, μ₁, K₂, μ₂, and pore aspect ratio a 725. A person of ordinary skill in the art will appreciate that inclusions of shapes other than ellipsoids may alternatively be modeled without departing from the scope of the disclosure.

The SC model may also model the rock as a composite where the pores are inclusions:

$${f}_{i} ( {K}_{i} - K ) {P}^{i} + ( 1 - {f}_{i} ) ( {K}_{h} - K ) {P}^{h} = 0 , \qquad Equation ( 13 )$$

$$and$$

$${f}_{i} ( {μ}_{i} - μ ) {Q}^{i} + ( 1 - {f}_{i} ) ( {μ}_{h} - μ ) {Q}^{h} = 0. \qquad Equation ( 14 )$$

Equations (13) and (14) model the rock with one host phase and one inclusion phase. In these equations, Kₕ and μₕ are bulk and shear moduli of the host constituent and Kᵢ and μᵢ are bulk and shear moduli of the inclusion, respectively. Further, fᵢ is the volume fraction of the inclusion. Further still, P and Q are geometrical factors where the superscript i or h indicate that the factor is for the material of elastic moduli Kᵢ and μᵢ or Kₙ and μₙ in a background medium of elastic moduli K and μ. Equations (13) and (14) may be solved iteratively.

Some models 720 may model the pore aspect ratio a 725 of the inclusions where a=l/L, l is the minor axis dimension of each inclusion, and L is the major axis dimension of each inclusion. The pore aspect ratio a 725 may be referred to as an equivalent pore aspect ratio (EPAR). If a model 720 models bulk modulus K, EPAR may be specifically denoted as K-EPAR or aₖ. If a model 720 models shear modulus μ, EPAR may be specifically denoted as μ-EPAR or a_{μ}. However, hereinafter, the variable a is used to generically denote any pore aspect ratio 725. In some embodiments, the pore aspect ratio a 725 may be between 0.1 and 0.2, inclusive. By way of example, FIG. 7 shows two models 720 generated using the DEM model where each model 720 is based on one pore aspect ratio a 725, 0.1 or 0.2.

The position 410 associated with each point 715 that exists within a mechanical parameter threshold 520 of the model 720 and within a porosity threshold 525 of the model 720, as shown by the dashed lines in FIG. 7 relative to the model where a=0.2, may then be identified as a position 410 within the second candidate interval 625. In some embodiments, the value of the mechanical parameter threshold 520 and porosity threshold 525 may be determined from rock core studies from one or more wells 205.

As shown by the key 730 in FIG. 7, separating mechanical values by the mechanical parameter threshold 520 and associated porosity values by the porosity threshold 525 may separate the associated positions 410 within the first candidate interval by, for the most part, class I and class II. As such, the second candidate interval may only include, for the most part, class II. Here, class I may categorize rock as having dominant intercrystalline micropores 100 with a total pore volume of greater than 90% and class II may categorize rock as having less dominant intercrystalline micropores 100 with a total pore volume between 50-90%.

Water saturation data is then determined along the second candidate interval 625 using, at least in part, the well data 400. The water saturation data includes water saturation values, each of which is associated to a position 410 within the second candidate interval 625. In some embodiments, the water saturation value may be determined at each position 410 by performing a regression analysis relative to the empirical Archie equation:

$$RI = \frac{{R}_{t}}{{R}_{o}} = \frac{1}{{ϕ}^{m} {S}_{w}^{n}} , \qquad Equation ( 15 )$$

where RI is the resistivity index, S_{w} is the water saturation of the uninvaded zone of the formation 210, n is a saturation exponent, ϕ is porosity, m is a cementation exponent, Rt is the true resistivity of the formation 210 (i.e., the resistivity of the formation 210 at S_{w}), and R₀ is the resistivity of the formation 210 when S_{w}=100%. A person of ordinary skill in the art will appreciate that the Archie equation may take modified forms relative to Equation (15). For example, ϕ and m may be excluded from Equation (15) without departing from the scope of the disclosure.

In general, the value of the saturation exponent n may be assumed to be roughly between 1.8 and 4.0. For example, the saturation exponent n may be around 2.0 for sandstone and carbonate dominated by intergranular pores. In another example, the saturation exponent n may be less than 2.0 for carbonate with micropores 100 categorized as type I or type II due to unique pore shape as assuming the saturation exponent n to be 2.0 may lead to an overestimation of water saturation S_{w}. In general, the value of the cementation exponent m may be roughly between 1.0 and 3.0. The remaining variables in Equation (15) may be measured from rock cores 215 in a laboratory setting.

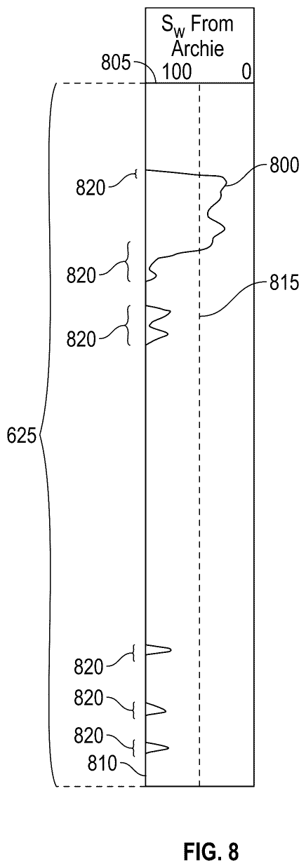

FIG. 8 displays water saturation data 800 along the second candidate interval 625 in accordance with one or more embodiments. The water saturation data 800 is plotted along the abscissa 805. The second candidate interval 625 is plotted along the ordinate 810. The water saturation threshold 815 is shown by the dashed line. In some embodiments, the water saturation threshold 815 may be based on rock core studies from one or more wells 205. In some embodiments, the water saturation threshold 815 may be 50%. Each position 410 associated with a water saturation value that exists above the water saturation threshold 815 may be identified as a position 410 within the productive interval 820.

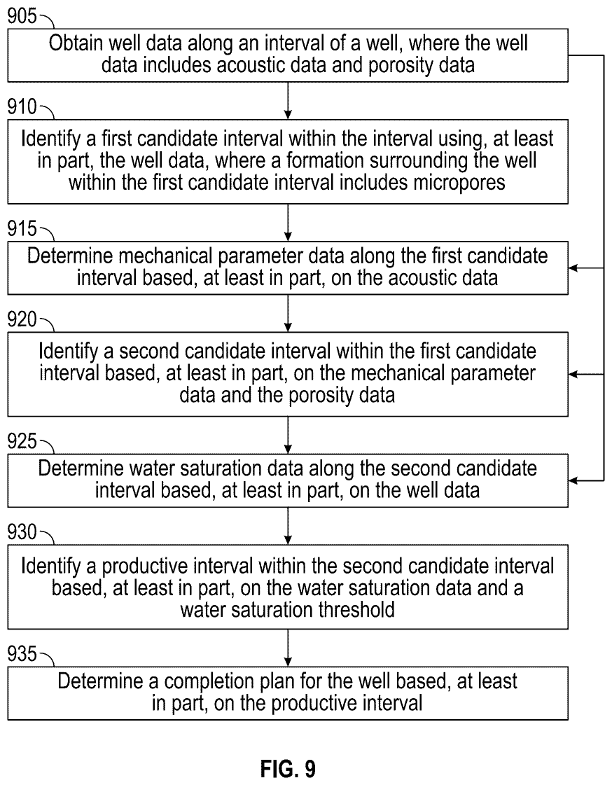

FIG. 9 shows a method in accordance with one or more embodiments. In step 905, well data 400 is obtained along an interval 405 of a well 205. The well data 400 includes acoustic data 415 and porosity data 420 examples of which are displayed in FIG. 4. The well data 400 may further include, but are not limited to, density data 425 and NMR data 430. Each of the well data 400 may be determined or derived from well logs and/or measured from rock cores 215.

In step 910, a first candidate interval 600 is identified within the interval 405 using, at least in part, the well data 400. The formation 210 surrounding the well 205 within the first candidate interval 600 includes rock with micropores 100. In some embodiments, the first candidate interval 600 is identified within the interval 405 using the NMR data 430 and a transverse relaxation time threshold 435 as previously described relative to FIG. 4. In some embodiments, the transverse relaxation time threshold 435 may be between 200 ms and 300 ms, inclusive. In other embodiments, the first candidate interval 600 is identified within the interval 405 using SEM images of core plugs. Each image associated with a position 410 within the interval 405 is of pores. Each image associated with a position 410 within the first candidate interval 600 is of micropores 100.

In step 915, mechanical parameter data 500 is determined along the first candidate interval 600 based, at least in part, on the acoustic data 415 among the well data 400. The mechanical parameter may include, but is not limited to, Young's modulus, bulk modulus, or shear modulus. The mechanical parameter data 500 includes mechanical values, each of which is associated with a position 410 within the first candidate interval 600. In some embodiments, a value of Young's modulus may be determined for each position 410 within the first candidate interval 600 using the acoustic data 415, density data 425, and Equation (3). In some embodiments, a value of bulk modulus may be determined for each position 410 within the first candidate interval 600 using the acoustic data 415, density data 425, and Equation (4).

In step 920, a second candidate interval 625 is determined within the first candidate interval 600 based, at least in part, on the mechanical parameter data 500 and the porosity data 420. Each mechanical value among the mechanical parameter data 500 and associated porosity value among the porosity data 420 is associated to a position 410 within the first candidate interval 600. In some embodiments, the second candidate interval 625 may be further based on a mechanical parameter threshold 520 and porosity threshold 525 as described relative to FIGS. 5-7. In some embodiments, each position 410 within the first candidate interval 600 where the associated mechanical value is below the mechanical parameter threshold 520 and the associated porosity value is above the porosity threshold 525 is a position 410 within the second candidate interval 625 as described relative to FIGS. 5 and 6. In other embodiments, the second candidate interval 625 may be further based on a model 720 as described relative to FIG. 7. The methods used to generate one or more models 720 include, but are not limited to, the HS+ method, HS-method, DEM model, SC model, and combinations thereof as previously described relative to Equations (5)-(14). Recall that each model 720 may be based on a pore aspect ratio a 725. In these embodiments, each position 410 within the first candidate interval 600 where the associated mechanical value is within the mechanical parameter threshold 520 of the model 720 and the associated porosity value is within the porosity threshold 525 of the model 720 is a position 410 within the second candidate interval 625. A person of ordinary skill in the art will appreciate that a combination of these embodiments may be performed to increase confidence in determining the second candidate interval 625.

In step 925, water saturation data 800 is determined along the second candidate interval 625 based, at least in part, on the well data 400. In some embodiments, each water saturation value among the water saturation data 800 associated to a position 410 within the second candidate interval 625 is determined using Equation (15) along with well data 400 determined from rock cores 215.

In step 930, a productive interval 820 is identified within the second candidate interval 625 based, at least in part, on the water saturation data 800 and a water saturation threshold 815. In some embodiments, the water saturation threshold 815 may be 50% as illustrated in FIG. 8.

In step 935, a completion plan is determined for the well 205 based, at least in part, on the productive interval 820. If the reservoir 315 is a carbonate or sandstone reservoir, the completion plan may include where to induce hydraulic fractures within the reservoir 315 based on the location of the productive interval 820 such that hydrocarbons may be produced.

Turning to systems, a computer system may be configured to perform steps 905, 910, 915, 920, 925, and 930. A production management system may be configured to perform step 935 to determine a completion plan. A hydraulic fracturing system may be configured to complete the well 205 based, at least in part, on the completion plan.

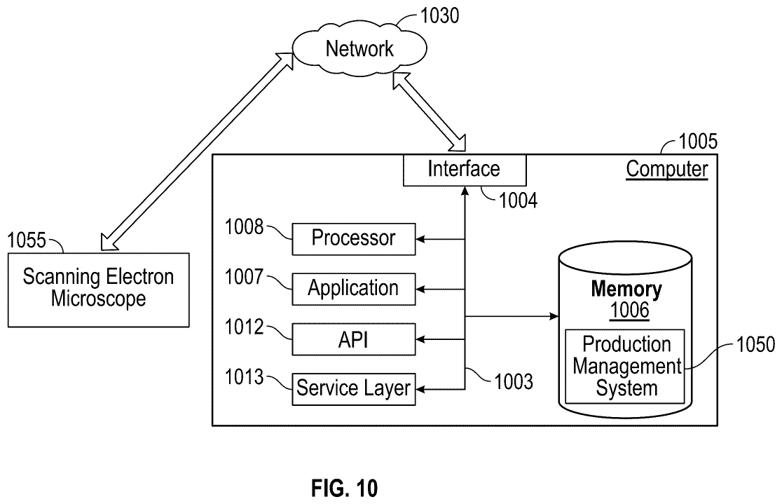

FIG. 10 illustrates a computer system 1005 in accordance with one or more embodiments. The computer system 1005 may be used to provide computational functionalities associated with described algorithms, methods, functions, processes, flows, and procedures as described in this disclosure, according to one or more embodiments. The illustrated computer 1005 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1005 may include a computer that includes an input device, such as a keypad, keyboard, touch screen, or other device that can accept user information, and an output device that conveys information associated with the operation of the computer 1005, including digital data, visual, or audio information (or a combination of information), or a GUI.

The computer 1005 can serve in a role as a client, network component, a server, a database or other persistency, or any other component (or a combination of roles) of a computer system for performing the subject matter described in the instant disclosure. The illustrated computer 1005 is communicably coupled with a network 1030. In some implementations, one or more components of the computer 1005 may be configured to operate within environments, including cloud-computing-based, local, global, or other environment (or a combination of environments). Further, in some embodiments, the computer system 1005 may be communicably coupled to a scanning electron microscope 1055 via the network 1030.

At a high level, the computer 1005 is an electronic computing device operable to receive, transmit, process, store, or manage data and information associated with the described subject matter. According to some implementations, the computer 1005 may also include or be communicably coupled with an application server, e-mail server, web server, caching server, streaming data server, business intelligence (BI) server, or other server (or a combination of servers).

The computer 1005 can receive requests over network 1030 from a client application (for example, executing on another computer 1005) and responding to the received requests by processing the said requests in an appropriate software application. In addition, requests may also be sent to the computer 1005 from internal users (for example, from a command console or by other appropriate access method), external or third-parties, other automated applications, as well as any other appropriate entities, individuals, systems, or computers.

Each of the components of the computer 1005 can communicate using a system bus 1003. In some implementations, any or all of the components of the computer 1005, both hardware or software (or a combination of hardware and software), may interface with each other or the interface 1004 (or a combination of both) over the system bus 1003 using an application programming interface (API) 1012 or a service layer 1013 (or a combination of the API 1012 and service layer 1013. The API 1012 may include specifications for routines, data structures, and object classes. The API 1012 may be either computer-language independent or dependent and refer to a complete interface, a single function, or even a set of APIs. The service layer 1013 provides software services to the computer 1005 or other components (whether or not illustrated) that are communicably coupled to the computer 1005. The functionality of the computer 1005 may be accessible for all service consumers using this service layer. Software services, such as those provided by the service layer 1013, provide reusable, defined business functionalities through a defined interface. For example, the interface may be software written in JAVA, C++, or other suitable language providing data in extensible markup language (XML) format or another suitable format. While illustrated as an integrated component of the computer 1005, alternative implementations may illustrate the API 1012 or the service layer 1013 as stand-alone components in relation to other components of the computer 1005 or other components (whether or not illustrated) that are communicably coupled to the computer 1005. Moreover, any or all parts of the API 1012 or the service layer 1013 may be implemented as child or sub-modules of another software module, enterprise application, or hardware module without departing from the scope of this disclosure.

The computer 1005 includes an interface 1004. Although illustrated as a single interface 1004 in FIG. 10, two or more interfaces 1004 may be used according to particular needs, desires, or particular implementations of the computer 1005. The interface 1004 is used by the computer 1005 for communicating with other systems in a distributed environment that are connected to the network 1030. Generally, the interface 1004 includes logic encoded in software or hardware (or a combination of software and hardware) and operable to communicate with the network 1030. More specifically, the interface 1004 may include software supporting one or more communication protocols associated with communications such that the network 1030 or interface's hardware is operable to communicate physical signals within and outside of the illustrated computer 1005.

The computer 1005 includes at least one computer processor 1008. Although illustrated as a single computer processor 1008 in FIG. 10, two or more processors may be used according to particular needs, desires, or particular implementations of the computer 1005. Generally, the computer processor 1008 executes instructions and manipulates data to perform the operations of the computer 1005 and any algorithms, methods, functions, processes, flows, and procedures as described in the instant disclosure.

The computer 1005 also includes a memory 1006 that holds data for the computer 1005 or other components (or a combination of both) that can be connected to the network 1030. For example, the memory 1006 may store a production management system 1050 that may be configured to perform step 935 as previously described relative to FIG. 9. Although illustrated as a single memory 1006 in FIG. 10, two or more memories may be used according to particular needs, desires, or particular implementations of the computer 1005 and the described functionality. While memory 1006 is illustrated as an integral component of the computer 1005, in alternative implementations, memory 1006 can be external to the computer 1005.

The application 1007 is an algorithmic software engine providing functionality according to particular needs, desires, or particular implementations of the computer 1005, particularly with respect to functionality described in this disclosure. For example, application 1007 can serve as one or more components, modules, applications, etc. Further, although illustrated as a single application 1007, the application 1007 may be implemented as multiple applications 1007 on the computer 1005. In addition, although illustrated as integral to the computer 1005, in alternative implementations, the application 1007 can be external to the computer 1005.

There may be any number of computers 1005 associated with, or external to, a computer system containing a computer 1005, wherein each computer 1005 communicates over network 1030. Further, the term “client,” “user,” and other appropriate terminology may be used interchangeably as appropriate without departing from the scope of this disclosure. Moreover, this disclosure contemplates that many users may use one computer 1005, or that one user may use multiple computers 1005.

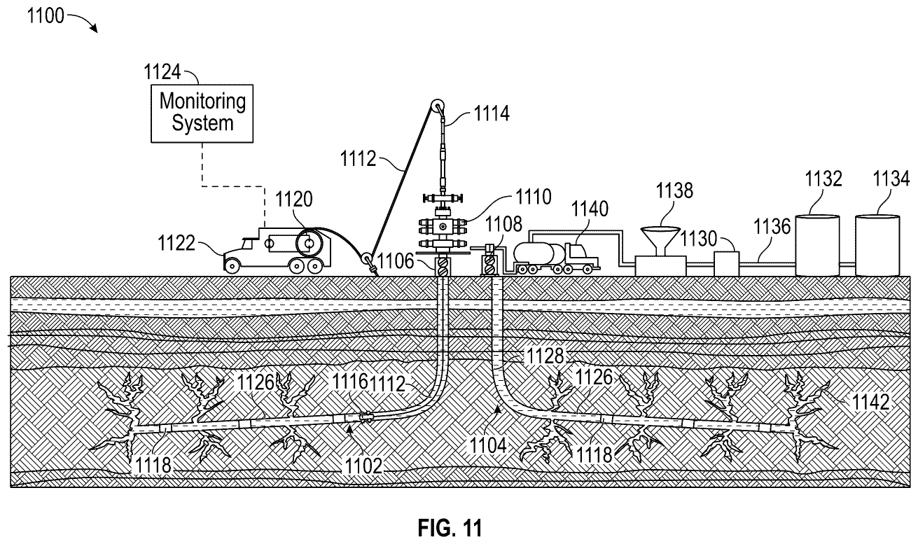

FIG. 11 illustrates a hydraulic fracturing system 1100 performing a hydraulic fracturing operation in accordance with one or more embodiments. The hydraulic fracturing system 1100 and hydraulic fracturing operation are for illustration purposes only. The scope of the disclosure is intended to encompass any type of hydraulic fracturing system 1100 and hydraulic fracturing operation. In some embodiments, the production management system 1050 may transfer variables associated with the completion plan to the hydraulic fracturing system 1100 via the network 1030 such that the hydraulic fracturing system 1100 may perform the hydraulic fracturing operation at the location of the productive interval 820.

In some embodiments, the hydraulic fracturing operation is performed by separating the well 205 into multiple packed wellbore lengths and fracturing each productive interval 820 in “stages.” Further, the hydraulic fracturing operation may be performed on multiple wells 205 that are geographically grouped. A single well 205 may have anywhere from one to more than forty stages. Typically, each stage includes one perforation operation and one pumping operation. While one operation is occurring on one well 205, a second operation may be performed on the other well 205. As such, FIG. 11 shows a hydraulic fracturing operation occurring on a first well 1102 and a second well 1104. The first well 1102 is undergoing the perforation operation and the second well 1104 is undergoing the pumping operation.

The first well 1102 and the second well 1104 are horizontal wells meaning that each well includes a vertical section and a lateral section. The lateral section is a section of the well that is drilled at least eighty degrees from vertical. The first well 1102 is capped by a first frac tree 1106 and the second well 1104 is capped by a second frac tree 1108. Those of ordinary skill in the art will appreciate that the use of the term “frac” refers to “fracturing” and is used herein to describe elements that may be used in a fracturing operation. A frac tree 1106, 1108 is similar to a Christmas/production tree but is specifically installed for the hydraulic fracturing operation. The frac trees 1106, 1108 tend to have larger bores and higher-pressure ratings than a Christmas/production tree would have. Further, hydraulic fracturing operations require abrasive materials being pumped into the wells 1102, 1104 at high pressures, so the frac tree 1106, 1108 is designed to handle a higher rate of erosion.

In some embodiments, the first well 1102 and the second well 1104 each require four stages. Both the first well 1102 and the second well 1104 have undergone three stages and are undergoing the fourth stage. The second well 1104 has already undergone the fourth stage perforation operation and is currently undergoing the fourth stage pumping operation. The first well 1102 is undergoing the fourth stage perforating operation and has yet to undergo the fourth stage pumping operation.

In some embodiments, the perforating operation includes installing a wireline blow out preventor (BOP) 1110 onto the first frac tree 1106. A wireline BOP 1110 is similar to a drilling BOP. However, a wireline BOP 1110 has seals designed to close around (or shear) wireline 1112 rather than drill pipe. A lubricator 1114 is connected to the opposite end of the wireline BOP 1110. A lubricator 1114 is a long, high-pressure pipe used to equalize between downhole pressure and atmosphere pressure to run downhole tools, such as a perforating gun 1116, into the first well 1102.

The perforating gun 1116 is pumped into the first well 1102 using the lubricator 1114, wireline 1112, and fluid pressure. In accordance with one or more embodiments, the perforating gun 1116 is equipped with explosives and a frac plug 1118 prior to being deployed in the first well 1102. The wireline 1112 is connected to a spool 1120 often located on a wireline truck 1122. Electronics (not pictured) included in the wireline truck 1122 are used to control the unspooling/spooling of the wireline 1112 and are used to send and receive messages along the wireline 1112. The electronics may also be connected, wired or wirelessly, to a monitoring system 1124 that is used to monitor and control the various operations being performed by the hydraulic fracturing system 1100.

When the perforating gun 1116 reaches a predetermined depth, a message is sent along the wireline 1112 to set the frac plug 1118. After the frac plug 1118 is set, another message is sent through the wireline 1112 to detonate the explosives, as shown in FIG. 11. The explosives create perforations in the wellbore casing 1126 and in the surrounding formation 210. There may be more than one set of explosives on a singular perforating gun 1116, each detonated by a distinct message. Multiple sets of explosives are used to perforate different depths along the casing 1126 for a singular stage. Further, the frac plug 1118 may be set separately from the perforation operation without departing from the scope of the disclosure herein.

As explained above, FIG. 11 shows the second well 1104 undergoing the pumping operation after the fourth stage perforating operation has already been performed and perforations are left behind in the casing 1126 and the surrounding formation 210. A pumping operation includes pumping a frac fluid 1128 into the perforations to propagate the perforations and create fractures 1142 in the surrounding formation 210. The frac fluid 1128 often includes a certain percentage of water, proppant, and chemicals.

FIG. 11 further shows chemical storage containers 1130, water storage containers 1132, and proppant storage containers 1134 that are constituents of the hydraulic fracturing system 1100. Frac lines 1136 and transport belts (not pictured) transport the chemicals, proppant, and water from the storage containers 1130, 1132, 1134 into a frac blender 1138. Sensors (not pictured) are located throughout this equipment to send signals to the monitoring system 1124. The monitoring system 1124 may be used to control the volume of water, chemicals, and proppant used in the pumping operation.

The frac blender 1138 blends the water, chemicals, and proppant to become the frac fluid 1128. The frac fluid 1128 is transported to one or more frac pumps, often pump trucks 1140, to be pumped through the second frac tree 1108 into the second well 1104. Each pump truck 1140 includes a pump designed to pump the frac fluid 1128 at a certain pressure. More than one pump truck 1140 may be used at a time to increase the pressure of the frac fluid 1128 being pumped into the second well 1104. The frac fluid 1128 is transported from the pump truck 1140 to the second frac tree 1108 using frac lines 1136.

The fluid pressure propagates and creates the fractures 1142 while the proppant props open the fractures 1142 once the pressure is released. Different chemicals may be used to lower friction pressure, prevent corrosion, etc. The pumping operation may be designed to last a certain length of time to ensure the fractures 1142 have sufficiently propagated. Further, the frac fluid 1128 may have different make ups throughout the pumping operation to optimize the pumping operation without departing from the scope of the disclosure herein.

When the hydraulic fracturing operation is completed on either well 1102, 1104, the frac tree 1106, 1108 must be removed from each well 1102, 1104 to perform the final completion operations which include drilling out the plugs 1118 using coiled tubing or a snubbing unit and installing production tubing (not pictured). The production tubing is installed by running the length of production tubing into each well 1102, 1104 and landing out the tubing hanger (i.e., the surface extending portion of the production tubing that has seals) into a tubing head that caps each well 1102, 1104.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method comprising:
obtaining well data along an interval of a well,
wherein the well data comprises acoustic data and porosity data;
identifying a first candidate interval within the interval using, at least in part, the well data,
wherein a formation surrounding the well within the first candidate interval comprises micropores;
determining mechanical parameter data along the first candidate interval based, at least in part, on the acoustic data;
identifying a second candidate interval within the first candidate interval based, at least in part, on the mechanical parameter data and the porosity data;
determining water saturation data along the second candidate interval based, at least in part, on the well data;
identifying a productive interval within the second candidate interval based, at least in part, on the water saturation data and a water saturation threshold; and
determining a completion plan for the well based, at least in part, on the productive interval.

2. The method of claim 1, further comprising completing the well based, at least in part, on the completion plan, wherein the completion plan comprises information on where to induce hydraulic fractures within a reservoir associated with the well based on a location of the productive interval.

3. The method of claim 1, wherein identifying the first candidate interval comprises:
obtaining a nuclear magnetic resonance (NMR) log along the interval of the well,
wherein the well data further comprises the NMR log; and
identifying the first candidate interval within the interval where the NMR log is below a transverse relaxation time threshold.

4. The method of claim 3, wherein the transverse relaxation time threshold is between 200 milliseconds and 300 milliseconds, inclusive.

5. The method of claim 1, wherein identifying the first candidate interval comprises:
obtaining rock cores along the interval of the well;
generating, using scanning electron microscopy, an image of each of the rock cores,
wherein the image of each of the rock cores is of pores; and
identifying the first candidate interval within the interval where the image of each of the rock cores is of the micropores.

6. The method of claim 1, wherein the second candidate interval within the first candidate interval is identified where a mechanical value among the mechanical parameter data is below a mechanical parameter threshold and a porosity value among the porosity data is above a porosity threshold,
wherein the mechanical value and the porosity value are associated to a position within the second candidate interval.

7. The method of claim 6, wherein the mechanical parameter data comprises Young's modulus data.

8. The method of claim 1, wherein identifying the second candidate interval comprises:
determining, using a differential effective medium (DEM) model, a model between a mechanical parameter and porosity for a pore aspect ratio; and
identifying the second candidate interval within the first candidate interval where a mechanical value among the mechanical parameter data is within a mechanical parameter threshold of the model and a porosity value among the porosity data is within a porosity threshold of the model,
wherein the mechanical value and the porosity value are associated to a position within the second candidate interval.

9. The method of claim 8, wherein the pore aspect ratio is between 0.1 and 0.2, inclusive.

10. The method of claim 1, wherein the formation surrounding the well within the second candidate interval comprises euhedral texture and/or subhedral texture.

11. The method of claim 1, wherein the water saturation data is determined using an Archie equation.

12. The method of claim 1, wherein the water saturation threshold is greater than 50%.

13. The method of claim 1, wherein the formation surrounding the well within the productive interval comprises carbonate.

14. A system comprising:
a computer system configured to:
receive well data along an interval of a well,
wherein the well data comprises acoustic data and porosity data,
identify a first candidate interval within the interval using, at least in part, the well data,
wherein a formation surrounding the well within the first candidate interval comprises micropores,
determine mechanical parameter data along the first candidate interval based, at least in part, on the acoustic data,
identify a second candidate interval within the first candidate interval based, at least in part, on the mechanical parameter data and the porosity data,
determine water saturation data along the second candidate interval based, at least in part, on the well data, and
identify a productive interval within the second candidate interval based, at least in part, on the water saturation data and a water saturation threshold; and
a production management system configured to:
determine a completion plan for the well based, at least in part, on the productive interval.

15. The system of claim 14, further comprising a hydraulic fracturing system configured to complete the well based, at least in part, on the completion plan, wherein the completion plan comprises information on where to induce hydraulic fractures within a reservoir associated with the well, based on a location of the productive interval.

16. The system of claim 14, further comprising a well logging system configured to obtain, at least in part, the well data.

17. A non-transitory computer-readable memory having computer-executable instructions stored thereon that, when executed by a computer processor, perform steps comprising:
receiving well data along an interval of a well,
wherein the well data comprises acoustic data and porosity data;
identifying a first candidate interval within the interval using, at least in part, the well data,
wherein a formation surrounding the well within the first candidate interval comprises micropores;
determining mechanical parameter data along the first candidate interval based, at least in part, on the acoustic data;
identifying a second candidate interval within the first candidate interval based, at least in part, on the mechanical parameter data and the porosity data;
determining water saturation data along the second candidate interval based, at least in part, on the well data;
identifying a productive interval within the second candidate interval based, at least in part, on the water saturation data and a water saturation threshold; and
determining a completion plan for the well based, at least in part, on the productive interval.

18. The non-transitory computer-readable memory of claim 17, wherein identifying the first candidate interval comprises:
receiving a nuclear magnetic resonance (NMR) log along the interval of the well, wherein the well data further comprises the NMR log; and
identifying the first candidate interval within the interval where the NMR log is below a transverse relaxation time threshold.

19. The non-transitory computer-readable memory of claim 17, wherein the second candidate interval is identified where a mechanical value among the mechanical parameter data is below a mechanical parameter threshold and a porosity value among the porosity data is above a porosity threshold,
wherein the mechanical value and the porosity value are associated to a position within the second candidate interval.

20. The non-transitory computer-readable memory of claim 17, wherein identifying the second candidate interval comprises:
generating, using a differential effective medium (DEM) model, a model between a mechanical parameter and porosity for a pore aspect ratio; and
identifying the second candidate interval within the first candidate interval where a mechanical value among the mechanical parameter data is within a mechanical parameter threshold of the model and a porosity value among the porosity data is within a porosity threshold of the model,
wherein the mechanical value and the porosity value are associated to a position within the second candidate interval.
